(19) United States
(12) Patent Application Publication
(10) Pub. No.: US 2007/0250673 A1
(43) Pub. Date: Oct. 25, 2007

(54) Computer backup system

(76) Inventor: Max L. Eidswick, Fort Collins, CO (US)

Correspondence Address: HARNESS, DICKEY & PIERCE, P.L.C., P.O. BOX 828, BLOOMFIELD HILLS, MI, 48303, US

(21) Appl. No.: 11/411,216

(22) Filed: Apr. 25, 2006

(51) Int. Cl. G06F 12/16

(52) U.S. Cl. 711/162

(57) ABSTRACT

A computer program product for enabling a computer to backup a complete image of a primary storage device on a secondary storage device is provided. The computer program product includes a computer readable medium bearing software instructions for enabling predetermined operations. The predetermined operations include: monitoring the computer for idle periods; and automatically copying a complete image of data from the primary storage device to the secondary storage device during idle periods.

### BACKGROUND OF THE INVENTION

1. Technical Field

The present disclosure relates to methods and systems for backing up a computer storage medium.

2. Discussion

The statements in this section merely provide background information related to the present disclosure and may not constitute prior art.

With businesses and individuals becoming more reliant on computer systems, backing up data stored on the computer is becoming more and more important. Disaster recovery systems are designed to allow a computer user to retrieve information that was lost due to system failure, human inadvertent mistakes, and disasters. Unfortunately, many computer users view conventional backup systems as complicated and time consuming. In general, some users back up their data once a day or once a week, if at all.

Conventional backup systems can be scheduled to run during periods of down time. Most commonly users configure their backup systems to run at night. This allows a complete backup to be performed without interruption. If an interruption were to occur, the backup would have to be rescheduled, sometimes starting over from the beginning. Thus, delaying the time of completion and delaying the time at which a user can access the system.

Conventional backup systems copy data based on a file-by-file approach. The backups are performed according to the file system of the designated drive to be copied. The type of file system is determined from the type of operating system. For example, in the context of Microsoft® Windows®, a “c:\” boot disk drive may contain the operating system, user data applications, and a page file. Each file of the c:\ drive is copied to the backup device.

The file system approach backs up copies of files on the logical drive. In the case of Microsoft Windows 2000 and XP, this approach can be only partially complete because certain key operating system files are ‘locked’ open and cannot be copied while Windows is running. In addition, some of the more essential elements of the hard drive are not backed up. These elements are often key to restoring the original data on the storage medium, the boot disk. One example of this are ‘hidden’ maintenance partitions which major manufacturers provide with their computers, in addition to Windows, to allow their technical support personnel to help users to identify and correct problems. Without this information, a user is unable to restore a complete backup copy of the original system disk drive. Furthermore, the file system approach can be time consuming. Conventional systems commonly store the contents of a certain file (i.e. file.txt) to one or more non-sequential locations on the hard drive. The storage locations are determined based on availability. In order to backup the file, additional processing must take place in order to retrieve the entire file from the non-sequential locations.

### SUMMARY

Accordingly, a computer program product for enabling a computer to backup a complete image of a primary storage device on a secondary storage device is provided. The computer program product includes a computer readable medium bearing software instructions for enabling predetermined operations. The predetermined operations include: monitoring the computer for idle periods; and automatically copying a complete image of data from the primary storage device to the secondary storage device during idle periods.

In other features, a system for backing up a complete image of memory of a computer is provided. The system includes: a secondary storage device that electronically communicates with the computer; and a computer readable medium bearing software instructions for enabling the computer to perform predetermined operations. The predetermined operations include: copying a complete image of memory of a computer to the secondary storage device during computer idle periods; and maintaining a complete image of memory in the computer on the secondary storage device during computer idle periods.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagram depicting a personal desktop computer including an ongoing backup system in accordance with the teachings of this invention.

FIG. 2 is a diagram depicting tracks and sectors of non-volatile memory.

FIG. 3 is a diagram depicting the format of the data that is stored by the ongoing backup system.

FIG. 4 is a tree diagram illustrating an exemplary directory structure of the ongoing backup system.

FIG. 5 is a block diagram illustrating sub-modules of ongoing backup software.

FIG. 6 is a flowchart illustrating a complete refresh method performed by the ongoing backup software.

FIG. 7 is a flowchart illustrating a method of processing data performed by the ongoing backup software.

FIG. 8 is a flowchart illustrating a method of maintaining a complete image performed by the ongoing backup software.

FIG. 9 is a flowchart illustrating a method of message digesting performed by the ongoing backup software.

FIG. 10 is a flowchart illustrating a method of input/output filtering performed by the ongoing backup software.

FIG. 11 is a graphical user interface run by a backup manager of the ongoing backup software.

### DETAILED DESCRIPTION OF THE PREFERRED EMBODIMENTS

The following description is merely exemplary in nature and is not intended to limit the present disclosure, application, or uses. It should be understood that throughout the drawings, corresponding reference numerals indicate like or corresponding parts and features.

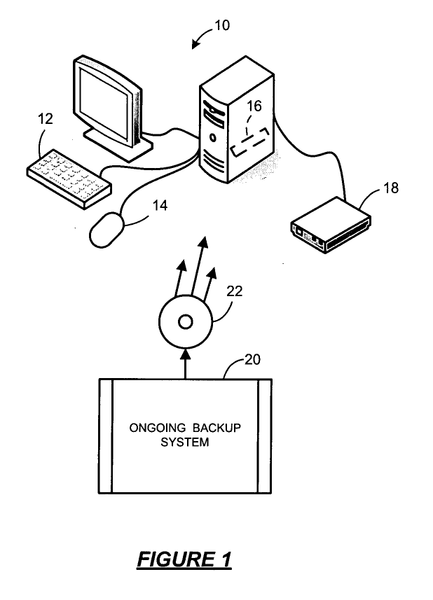

Referring to FIG. 1, a computer including an ongoing backup system is shown generally at 10. Although FIG. 1 depicts a personal desktop computer, it is appreciated that the ongoing backup system of the present disclosure is applicable to any computer system including desktop computers, laptop computers, mainframes, super computers, and servers. For ease of the discussion, the remainder of the disclosure will be discussed in the context of a personal desktop computer as shown in FIG. 1. The computer 10 is shown to be associated with one or more input devices 12 and 14 used by a user to communicate with the computer 10. As can be appreciated, such devises may include, but are not limited to, a mouse, a keyboard, a joystick, a microphone, and a touchpad.

The computer 10 includes a processor (not shown) and one or more data storage devices. The one or more data storage devices can be at least one of Random Access Memory (RAM), Read Only Memory (ROM), a cache, a stack, or the like which may temporarily or permanently store electronic data of the system. The computer 10 includes a primary non-volatile data storage device shown in phantom at 16 that stores data on a magnetic surface. The primary storage device 16 typically interacts with the processor and the other storage devices to permanently store information such as an operating system, software applications, and data files. It is appreciated that the computer 10 can include one or more primary storage devices 16.

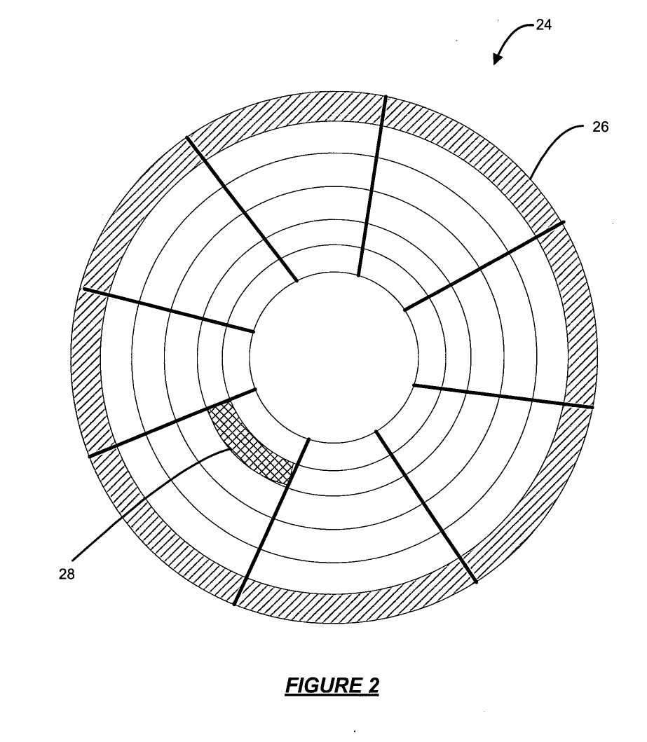

With reference to FIG. 2, in various embodiments the primary storage device 16 can include one or more hard disks 24 (also referred to as platters). Data is stored on the surface of the platter 24 in tracks 26 and sectors 28. Tracks 26 form concentric circles on the surface of the platter 24. Sectors 28 form pie-shaped segments of the circle. Each sector 28 contains a fixed number of bytes. Sectors 28 are often partitioned to allow for operating system specific logical formatting.

Referring back to FIG. 1, a secondary storage device 18 connects externally to the computer 10. The secondary storage device 18 may include one or more platters that are formatted similarly as described above. The secondary storage device 18 may be physically connected (as shown in FIG. 1) via a universal serial bus (USB) connection or the like. Alternatively, the secondary storage device 18 may be remotely located (not shown) and may communicate electronically to the computer 10 via the internet. Insofar as the present disclosure is concerned, communications between the computer 10 and the secondary storage device 18 will be according to any known communication protocol such as, but not limited to, USB, Wi-Fi, Bluetooth, TCP, and IEEE.

The processor (not shown) of the computer 10 is operable to execute one or more set of instructions contained in software. An ongoing backup software 20 is installed to the computer 10. As shown in FIG. 1, the ongoing backup software 20 may be embedded on a CD-ROM 22. The CD-ROM 22 includes installation software (not shown) to facilitate the installation of the ongoing backup software 20 onto the computer 10 by the user. The CD-ROM 22 may also include disaster recovery software (not shown) to allow the computer access to the data stored on the secondary storage device 18 in the event the data is needed. In various other embodiments, a backup box (not shown) including the secondary storage device 18 is connected to the computer 10. The backup box includes the installation software, the ongoing backup software 20, and the disaster recovery software. When connected to the computer 10, the backup box automatically installs the ongoing backup software 20 to the computer 10. The backup box can be connected and disconnected to the computer without a need for reinstallation of the ongoing backup software 20.

The ongoing backup software 20 is executed by the processor of the computer 10. The ongoing backup software 20 automatically maintains a complete image of the data stored on the primary storage device 16 in the secondary storage device 18. More specifically, the ongoing backup software 20 automatically maintains a complete image of the computer's system boot disk of the primary storage device 16 in the secondary storage device 18. A complete image of the primary storage device 16 is first copied. Thereafter, modified data is periodically updated to maintain a complete image. The data transfer is performed sequentially, during idle periods. Idle periods are automatically determined by the ongoing backup software 20 based on input device 12 and 14 inactivity and/or processor load.

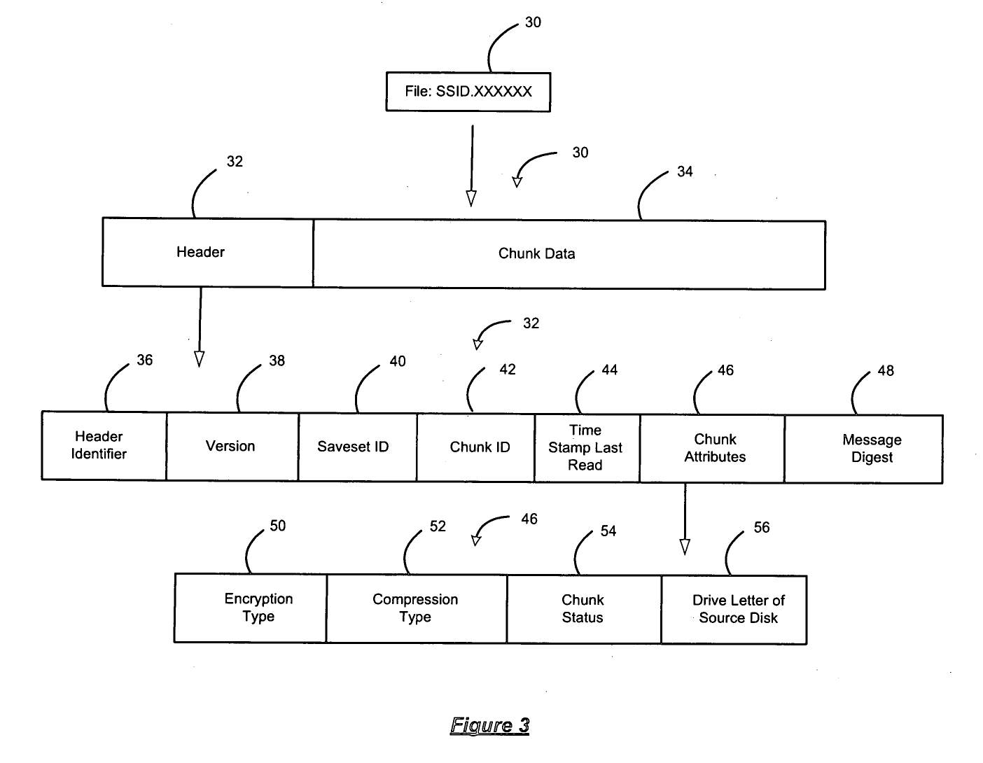

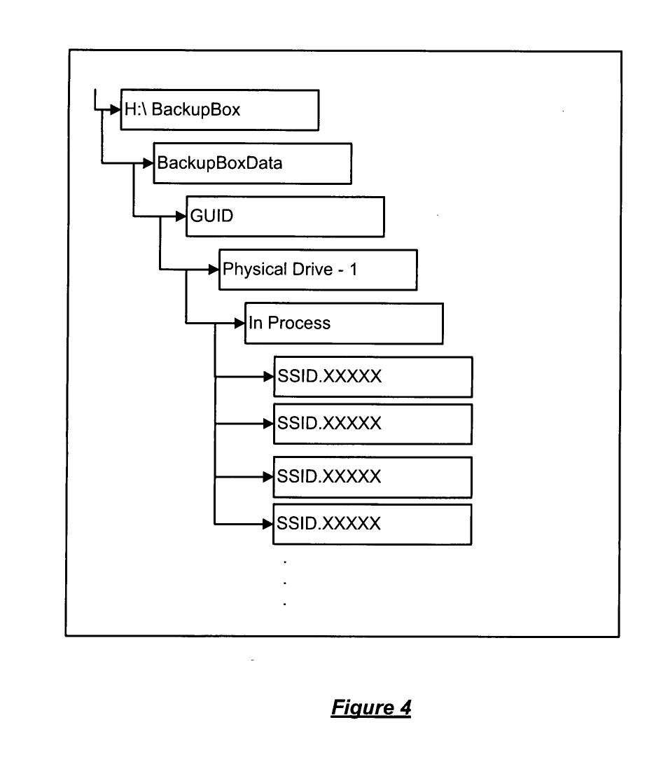

With reference to FIG. 3, the ongoing backup software 20 (FIG. 1) processes chunks of data on the primary storage device 16 (FIG. 1) starting at the beginning of the disk (i.e. sector one of FIG. 2). A chunk can be defined as a plurality of sectors 28 (FIG. 2). A chunk has no relation to the clusters designated by the operating system. In various embodiments, a chunk is equal to 4 megabytes or 8K sectors of contiguous disk data divided on integer boundaries. The ongoing backup software 20 processes and stores each chunk as a file 30 on the secondary storage device 18 (FIG. 1). The file can be named according to a saveset identification number and a chunk identification number (i.e. savesetID.chunkIDnumber). An exemplary file structure for the secondary storage device is shown in FIG. 4. The chunk files 30 are stored under an “in process” sub-directory of a “physical drive” directory. As can be appreciated, there can be more than one physical drive directory depending on how the primary storage device 16 is partitioned.

As shown in FIG. 3, each file 30 includes a header 32 and a single chunk of data 34. The header 32 includes pertinent information for processing the data 34. In various embodiments, the header 32 can be a data structure including data fields for: a header identifier 36, a software version 38, a saveset ID 40, a chunk ID 42, a time stamp 44, chunk attributes 46, and a message digest 48. The header 32 comprises roughly the first sixty-four bytes of the file 30. The header identifier 36 is a string identifier used for denoting the beginning of the header 32. When searching for header information, the header identifier 36 indicates that the bytes that follow contain header information. The version 38 indicates the version of the ongoing backup software 20 used to backup the chunk of data 34 in the file 30. The saveset ID 40 is an identification number that relates the chunk of data 34 to other data stored in other files. In various embodiments, the saveset ID 40 is a timestamp for when a complete image of the primary storage device 16 (FIG. 1) has been successfully copied. The chunk ID 42 is the identification number of the chunk of data 34 in relation to other chunks on the primary storage device 16 (FIG. 1). The time stamp 44 indicates the time at which the chunk of data 34 was last read from the primary storage device 16 (FIG. 1).

Chunk attributes 46 may include information related to the chunk of data 34 stored in the file 30. In various embodiments, the chunk attributes 46 include an encryption type 50, a compression type 52, a chunk status 54, and a drive letter of the source disk 56. The encryption type 50 indicates what type of encryption technique was used to encrypt the data stored on the secondary storage device 18 (FIG. 1). The compression type 52 indicates what type of compression technique was used to compress the data stored on the secondary storage device 18 (FIG. 1). The drive letter of source disk 56 indicates the location of the primary storage device 16 (FIG. 1) as indicated by a drive letter. The message digest 48 includes information that identifies the contents of the chunk of data 34. More particularly, the message digest 48 is a checksum computed from the chunk of data 34. Various digesting methods can be used to generate the message digest 48. Such methods may include, but are not limited to, SHA-1 and MD-5.

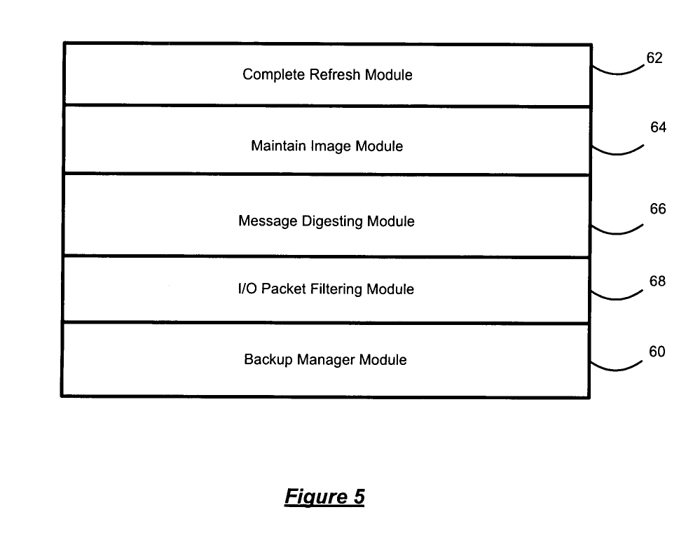

With reference to FIG. 5, the ongoing backup software 20 can be broken down into one or more software modules. The software modules shown may be combined and/or further partitioned to similarly backup the primary storage device. One or more modules may be executed as threads running as simultaneous tasks. In various embodiments, the ongoing backup software includes a backup manager module 60, a complete refresh module 62, a maintain image module 64, a message digesting module 66, and an input/output (I/O) filtering module 68.

The complete refresh module 62 copies a complete image of the data to the secondary storage device 18 (FIG. 1). Chunks of data 34 are sequentially copied during idle periods. A complete image is copied upon initialization of a new secondary storage device 18 (FIG. 1) and after certain trigger events occur (as will be discussed in more detail below). Once a complete image is copied, the maintain image module 64 continues to maintain a most current image by updating the secondary storage device 18 (FIG. 1) with chunks of data 34 that have changed on the primary storage device 16 (FIG. 1). The maintain image module 64 determines if the chunk of data 34 has changed based on the chunk status 54 in the header 32 (FIG. 3). The chunk status 54 is written to by the message digesting module 66 and the I/O filtering module 68.

The message digesting module 66 determines if chunks of data 34 on the primary storage device 16 (FIG. 1) have changed. If a chunk 34 has changed, the message digesting module 66 sets the chunk status 54 to indicate that the data in the chunk 34 has changed. In various embodiments, the message digesting module 66 sets a chunk status byte to TRUE. The I/O filtering module 68 monitors I/O request packets issued by the operating system. If the I/O request packet includes a write request, the I/O filtering module 68 sets the chunk status 54 to indicate that the data in the chunk 34 has changed. In various embodiments, I/O filtering module 68 sets the chunk status byte to TRUE. The backup manager module 60 manages backup status information and reports the information via a graphical user interface (GUI).

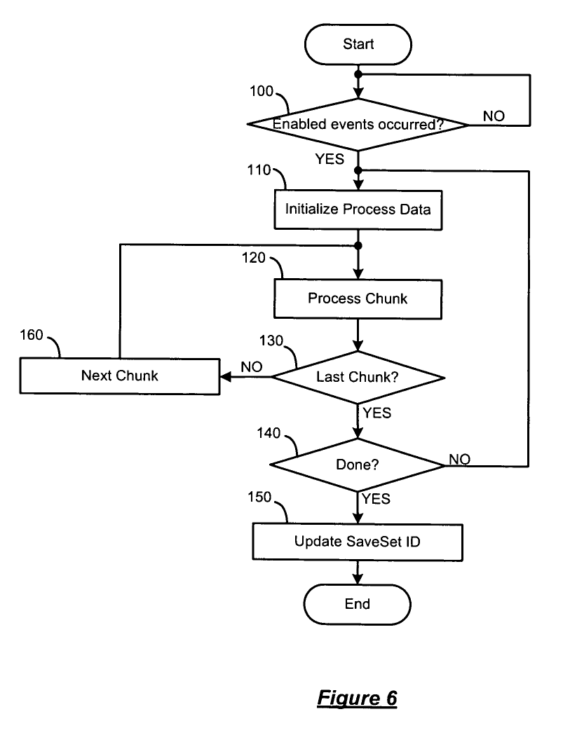

With reference to FIG. 6, a flowchart illustrating a method for performing a complete refresh performed by the complete refresh module of FIG. 5 is shown. The method may be run continually during computer operation. In various embodiments, the method sleeps periodically to allow other software applications access to the processor of the computer 10 (FIG. 1). Enable criteria are monitored at 100. If the ongoing backup software 20 (FIG. 1) was just installed, the user initiates a request for a complete refresh, or a trigger event occurs, then the enable criteria are met. Otherwise, the method continues to monitor the enable criteria at 100. If the enable criteria are met, the process data is initialized at 110. A single chunk of data is processed at 120.

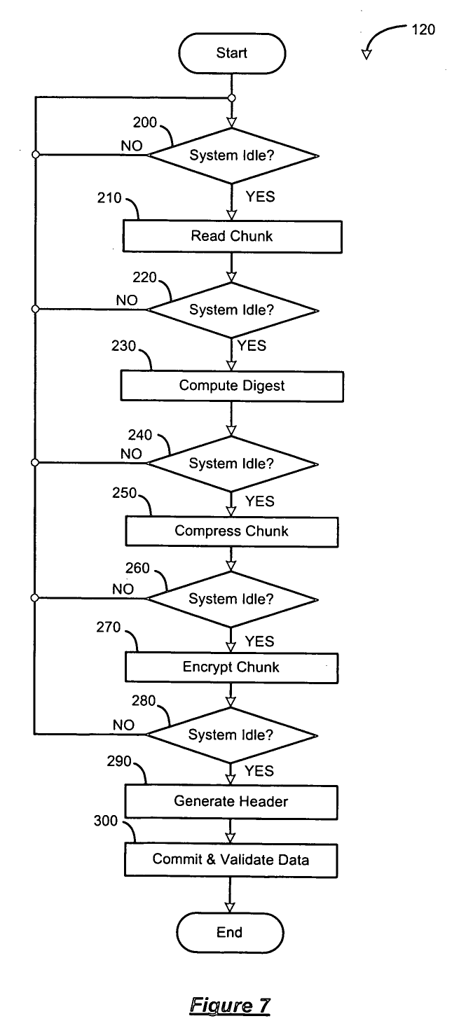

More specifically, with reference to FIG. 7 and continued reference to FIGS. 1 and 3, the computer 10 is monitored for idle periods at 200. An idle period can be defined by periods of inactivity by the computer and/or the computer user. In various embodiments, input devices 12 and 14 are monitored for periods of inactivity. In various other embodiments, the load on the processor is monitored for periods of inactivity. The period of inactivity can be configurable by the computer user. For example, a computer user may configure an idle period to be three minutes of input device inactivity.

If the computer is idle at 200, a single chunk of data 34 is read from the primary storage device at 210 beginning with the first chunk on the primary storage device 16. If the computer 10 remains idle at 220, the message digest 48 is computed using a cryptographic technique for the chunk of data 34 at 230. If the computer 10 remains idle at 240, the chunk of data 34 is compressed using one or more of various known compression techniques at 250. If the computer remains idle at 260, the compressed chunk of data 34 is encrypted using an encryption technique at 270. If the system remains idle at 280, a header 32 is generated containing the information as discussed in FIG. 3 at 290. The header 32 and the compressed, encrypted chunk of data is stored on the secondary storage device 18 in a file format as shown in FIG. 4 at 300. If during the read, compute, compress, encrypt, and write process, the system becomes active, the method loops back and waits to reprocess the current chunk of data until the computer 10 becomes idle at 200.

Referring back to FIG. 6, if the current processed chunk is not the last chunk or sequence of sectors on the primary storage device 16 at 130, the method moves on to the next sequential chunk of data on the primary storage device 16 at 140. The process chunk process 120 is continued for every chunk of data 34 on the primary storage device 16. If the current chunk is the last chunk or sequence of sectors on the primary storage device 16 at 130 and all of the data on the primary storage device 16 was processed during a single idle period at 140, then the refresh is complete and the savesetID 40 in the header 32 for each chunk is updated with the current timestamp and the data is sealed.

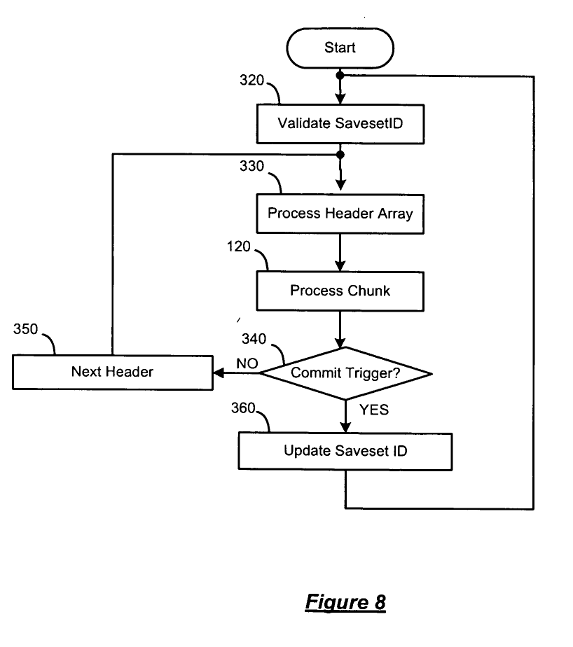

With reference to FIG. 8 and continued reference to FIGS. 1 and 3, a flowchart illustrates a method of maintaining a complete backup image performed by the maintain image module 64 of FIG. 5. The method may be configured to run continually during computer operation. In various embodiments, the method sleeps periodically to allow other software applications access to the processor of the computer 10 (FIG. 1). The method can be run once the complete refresh method of FIG. 6 has sealed the data. The method is run when the secondary storage device 18 is connected to the computer 10. The saveset ID 40 for each chunk of data is validated at 320. An array of headers is generated and the chunk status 54 of each header 32 is processed at 330. For each chunk of data 34 where the chunk status 54 indicates that the data has changed on the primary storage device 16, the corresponding chunk of data 34 is processed at 120. The method of processing the chunk of data 34 can be as discussed in FIG. 7, where the data is read, computed, compressed, encrypted, and written during idle periods.

If after processing the modified data, a trigger event occurs, the newly stored updated chunks of data are committed to a new saveset. Trigger events can include: time since last commit, time of saveset ID, direct I/O activity, and processor load. The saveset ID 40 of the header 32 for each chunk of data 34 is updated and the data is sealed at 360. Once the data is sealed, the method loops back and continues to maintain the complete image as described above.

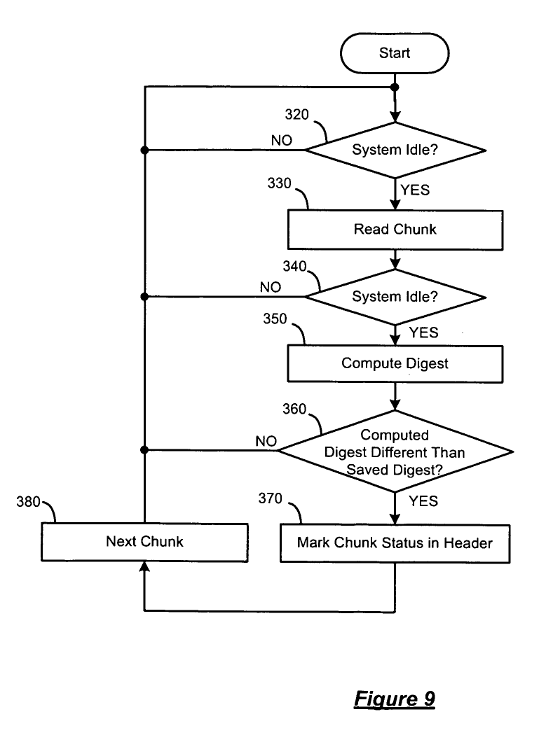

With reference to FIG. 9 and continued reference to FIGS. 1 and 3, a flowchart illustrating a method of message digesting performed by the message digesting module 66 of FIG. 5 is shown. The method can be run continually during computer operation. In various embodiments, the method sleeps periodically to allow other software applications access to the processor of the computer 10. If the system is idle at 320, a first chunk of data 34 is read from the primary storage device 16 at 330. A message digest 48 is computed for the chunk of data 34 at 340. The newly computed message digest is compared with the corresponding message digest saved in the header 32 on the secondary storage device 16 at 350. If the computed message digest is different than the saved message digest, the chunk status 54 of the header 32 is marked to indicate that the data has been modified at 360. The read, compute, and compare process is performed for all data stored on the primary storage device 16 in sequential increments while the system is idle.

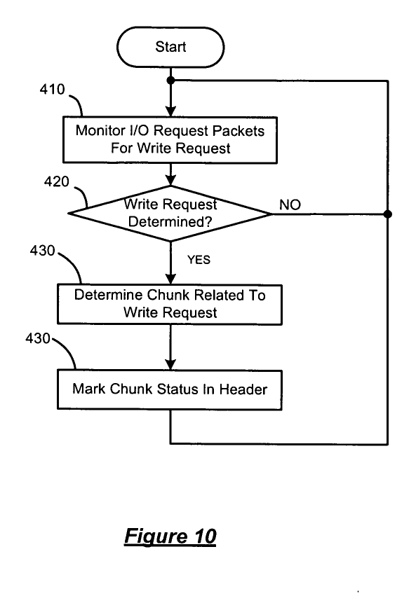

With reference to FIG. 10, a flowchart illustrating a method of I/O filtering performed by the I/O filtering module 68 of FIG. 5 is shown. The method can be run continually during computer operation. In various embodiments, the method sleeps periodically to allow other software applications access to the processor of the computer 10 (FIG. 1). I/O packet requests issued by the operating system are monitored at 410. If a write request is determined from the I/O packet request, the chunk of data relating to the write request is determined at 430. The chunk status 54 (FIG. 3) in the header 32 (FIG. 3) corresponding to the chunk of data 34 (FIG. 3) subject to the write request is marked to indicate that the data has been modified at 430. The method loops back and continues to monitor I/O request packets.

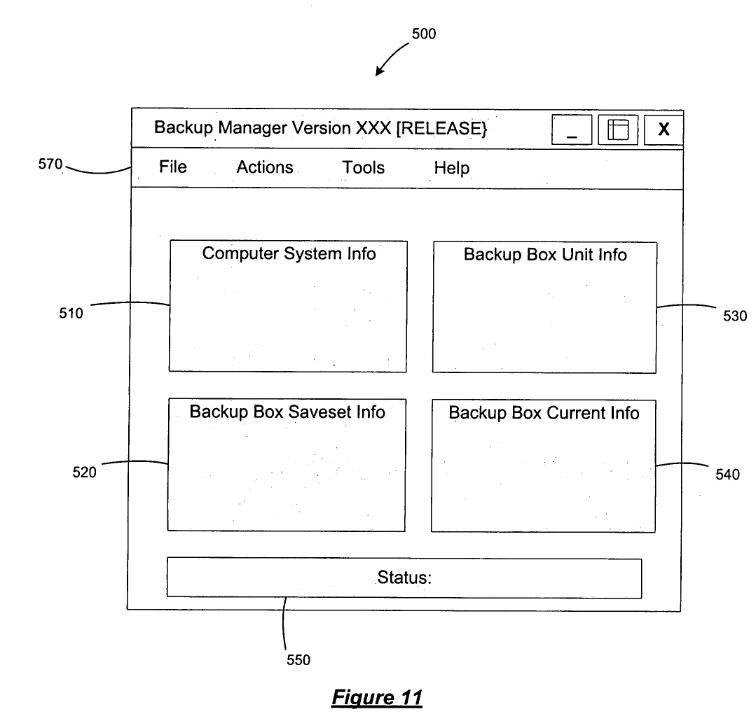

With reference to FIG. 11, a backup manager graphical user interface (GUI) 500 of the backup manager module 60 of FIG. 5 is shown. A computer user can view the status of the backup via the backup manager GUI 500. The backup manager GUI 500 includes: a computer system information dialogue box 510, a backup box unit information dialogue box 530, a backup box saveset information dialogue box 520, and a backup box current information dialogue box 540. The computer system information dialogue box 510 displays information about the primary storage device 16 (FIG. 1) such as size and space available. The backup box unit information dialogue box 530 displays information about the secondary storage device 18 (FIG. 1) such as size and space available. The backup box saveset information dialogue box 520 displays information about the saveset stored in the secondary storage device 18 (FIG. 1), such as the current saveset ID and the amount of data stored. The backup box current information dialogue box 540 displays information relating to the current status of the backup process.

A status bar 550 indicates a status of the secondary storage device 18 (FIG. 1). More particularly, the status indicates whether the validation of the memory in the secondary storage device is valid. The backup GUI can include a listing of drop-down menus 570. Drop-down menus can include: File, Actions, Tools, and Help. The file drop-down menu includes options to allow the user to access the files stored on the secondary storage device 18 (FIG. 1). The actions drop down menu includes options to allow the user to initiate a backup now request and to query for updated versions of the ongoing backup software. The tools drop down menu allows the computer user to configure and optimize the ongoing computer backup software parameters. The help drop down menu allows the user access to a library of resources to assist with the use of the ongoing backup software.

Those skilled in the art can now appreciate from the foregoing description that the broad teachings of the present disclosure can be implemented in a variety of forms. Therefore, while this disclosure has been described in connection with particular examples thereof, the true scope of the disclosure should not be so limited since other modifications will become apparent to the skilled practitioner upon a study of the drawings, specification, and the following claims.

What is claimed is:

1. A computer program product for enabling a computer to backup a complete image of a primary storage device of a computer on a secondary storage device, comprising:
a computer readable medium bearing software instructions for enabling predetermined operations, the predetermined operations including:
monitoring the computer for idle periods; and
automatically copying a complete image of data from the primary storage device to the secondary storage device during idle periods.

2. The computer program product of claim 1 wherein the primary storage device is the computer's system boot disk.

3. The computer program product of claim 1 wherein the predetermined operations further include:
comparing data from the primary storage device to data from the secondary storage device during idle periods; and
updating the data on the secondary storage device with the data from the primary storage device if data on the secondary storage device and the data from the primary storage device are different during idle periods.

4. The computer program product of claim 1 wherein the predetermined operations further include:
monitoring system input/output packet requests;
generating a list of data associated with write requests within the system input/output packet requests; and
for each data in the list, updating the data on the secondary storage device associated with the sectors with corresponding data in the primary storage device during idle periods.

5. The computer program product of claim 1 wherein the predetermined operation of monitoring for idle periods further includes monitoring at least one of input devices of the computer and processor load for inactivity.

6. The computer program product of claim 1 wherein the predetermined operation of monitoring for idle periods further includes monitoring the computer for inactivity during a configurable amount of time.

7. The computer program product of claim 1 wherein the automatically copying is preformed after at least one of startup conditions and event trigger conditions occur.

8. The computer program product of claim 3 wherein the comparing and the updating are performed when the automatically copying is complete and wherein the automatically copying is complete once a complete image of the primary storage device is stored during a single idle period.

9. The computer program product of claim 4 wherein the monitoring, the generating, and the updating are preformed when the automatically copying is complete and wherein the automatically copying is complete once a complete image of the primary storage device is stored during a single idle period.

10. The computer program product of claim 1 wherein the automatically copying further includes automatically copying chunks of data in sequential increments during idle periods wherein a chunk is defined as a plurality of sectors.

11. The computer program product of claim 3 wherein the comparing data and the updating the data includes comparing and updating chunks of data in sequential increments during idle periods wherein a chunk is defined as a plurality of sectors.

12. The computer program product of claim 11 wherein the predetermined operations further include:
generating a header including at least one of a header identifier, a software version identifier, a saveset identification, a chunk identification number, a last read time stamp, and a message digest for each chunk; and
storing the header and the data in a file format.

13. The computer program product of claim 12 wherein the generating a header further includes generating a header including at least one of an encryption type, a compression type, a chunk status, and a driver letter of source disk.

14. A method of storing data from a computer's primary storage device to a secondary storage device, comprising:
monitoring the computer for idle periods;
reading data from the primary storage device during idle periods;
computing a checksum from the data during idle periods;
generating header data associated with the data during idle periods; and
writing the data and the header data to the secondary storage device during idle periods.

15. The method of claim 14 further comprising:
compressing the data during idle periods;
encrypting the compressed data during idle periods; and
wherein the writing comprises writing the compressed and encrypted data to the secondary storage device during idle periods.

16. The method of claim 14 wherein the monitoring further comprises monitoring the computer for idle periods based on at least one of user input device inactivity and processor load.

17. The method of claim 14 wherein the generating header data further comprises generating a header including at least one of a header identifier, a software version identifier, a saveset identification, a chunk identification number, a last read time stamp, and a message digest for each chunk.

18. The method of claim 14 wherein the writing further comprises writing the data and the header data in a file format to the secondary storage device.

19. The method of claim 14 wherein the reading further comprises reading chunks of data from the primary storage device wherein a chunk is a plurality of sectors.

20. The method of claim 19 wherein the reading further comprises reading chunks of data sequentially during idle periods.

21. A method of enabling a computer to update a complete image stored from a primary storage device on a secondary storage device, comprising:
retrieving data from the primary storage device sequentially during idle periods;
computing a message digest from the data during idle periods;
comparing the computed message digest to a respective digest stored in the secondary storage device during idle periods; and
updating the data on the secondary storage device with the data from primary storage device if the computed message digest and the respective message digest from the secondary storage device are different.

22. The method of claim 21 further comprising monitoring for idle periods based on at least one of inactivity of computer peripheral devices and machine load.

23. The method of claim 21 wherein the computing a message digest further comprises computing a message digest using at least one of SHA-1 and MD-5.

24. A method of enabling a computer to update a complete image of data stored on a secondary storage device from data on a primary storage device, comprising:
monitoring input/output packet requests for a write request;
associating data on the primary storage device with the write request;
associating data on the secondary storage device with the write request;
monitoring the computer for idle periods; and
updating the data on the secondary storage device with the respective data from the primary storage device during idle periods.

25. The method of claim 24 wherein the monitoring further comprises monitoring the computer for idle periods based on at least one of user input device inactivity and processor load.

26. A system for backing up a complete image of a bootable disk of a computer, comprising:
a secondary storage device that electronically communicates with the computer;
a computer readable medium bearing software instructions for enabling the computer to perform predetermined operations, the predetermined operations including:
monitoring the computer for idle periods;
copying a complete image of a bootable disk in the computer to the secondary storage device during computer idle periods; and
maintaining a complete image of the bootable disk in the computer on the secondary storage device during computer idle periods.

26. The system of claim 26 wherein the predetermined operations further include:
recovering the complete bootable disk image from the secondary storage device upon request.

27. The system of claim 26 wherein the predetermined operations further include:
installing the software instructions that perform the copying and the maintaining to the computer.
